(19) United States
(12) Patent Application Publication
(10) Pub. No.: US 2008/0011545 A1
(43) Pub. Date: Jan. 17, 2008

(54) Safety harness accessory for reducing the risk of suspension trauma

(75) Inventor: Nina L. Turner, Morgantown, WV (US)

Correspondence Address: KLARQUIST SPARKMAN, LLP, 121 S.W. SALMON STREET, SUITE 1600, PORTLAND, OR, 97204, US

(73) Assignees: The Gov. of the USA as represented by the Secretary of the Dept. of Health & Human Services; Centers for Disease Control and Prevention

(21) Appl. No.: 11/799,281

(22) Filed: Apr. 30, 2007

Related U.S. Application Data
(60) Provisional application No. 60/831,260, filed on Jul. 14, 2006.

(51) Int. Cl. A62B 1/16

(52) U.S. Cl. 182/6

(57) ABSTRACT

The present disclosure concerns a fall arrest strap assembly that can reduce the risk of suspension trauma in a user of a fall-arrest body harness, and in particular, a fall arrest strap assembly that supports the user in a seated position with the knees elevated to at least hip level in the event of a fall from an elevated structure. The device deploys passively, so it is effective even when the user is injured or unconscious.

### CROSS REFERENCE TO RELATED APPLICATION

This application claims the benefit of U.S. provisional patent application Ser. No. 60/831,260, filed Jul. 14, 2006, which is incorporated herein by reference.

### ACKNOWLEDGMENT OF GOVERNMENT SUPPORT

The present invention was made by The National Institute for Occupational Safety and Health, Centers for Disease Control and Prevention, an agency of the United Sates Government. Therefore the United States Government may have certain rights in the invention.

### FIELD

The present disclosure concerns a fall arrest strap assembly that can be used with a fall-arrest body harness to reduce the risk of suspension trauma, and in particular, a fall arrest strap assembly that supports the user in a seated position with the knees elevated to at least hip level in the event of a fall from an elevated structure.

### BACKGROUND

A typical fall-arrest harness, such as commonly used by workers on elevated structures, is adapted to suspend a wearer in a near-vertical position in the event of a fall. Suspension trauma, a form of orthostatic intolerance, is a potentially fatal consequence of suspension in a full-body fall-arrest harness in a near-vertical position. The resulting sustained immobility in a vertical or near-vertical position can lead to pooling of blood in the veins of the legs, which reduces the return blood flow to the heart and causes fainting, a dramatic increase in heart rate, and a precipitous drop in blood pressure. The reduction in blood circulation also can damage vital organs such as the kidneys, resulting in renal failure. Depending on the length of time the suspended worker is unconscious or immobile and the level of venous pooling, the resulting orthostatic intolerance can lead to death.

In light of the foregoing, there is a need for an improved fall-arrest apparatus that reduces the risk of suspension trauma in the event of a fall.

### SUMMARY

The present disclosure concerns an improved fall-arrest apparatus that reduces the risk of suspension trauma in the event of a fall. In some embodiments, the fall-arrest apparatus includes a harness adapted to be worn around the torso of a user and a strap assembly adapted to be worn on the upper legs of the user. The harness and strap assembly are coupled to a lanyard that, in turn, is tied off at a location on an elevated structure. In the event of a fall from the elevated structure, the strap assembly supports the user in a seated position with the knees elevated to at least hip level.

In particular embodiments, the strap assembly includes at least one lower body strap assembly adapted to be worn on the user's upper legs, and in even more particular embodiments, the lower body strap assembly includes a first leg loop and a second leg loop, where each leg loop is adapted to extend around a respective upper leg of the user. In certain examples, the leg loops are coupled to connecting straps that, in turn, are coupled to the lanyard such that, in the event of a fall, the leg loops support the upper legs in a bent position relative to the upper body, and desirably the leg loops elevate the legs to a level at or above the level of the hips, which aids the return blood flow to the heart and prevents the user from developing suspension trauma. Optionally, the leg loops can be adjustable in circumference and can include padded portions. In addition, in some examples the lengths of connecting straps between the lanyard and the leg loops are adjustable, so as to be able to control the position of the legs in the event of a fall. In certain other examples, the fall-arrest apparatus also includes an upper body strap assembly that is coupled to the lanyard and to the harness to support the upper body when the user is suspended by the lanyard.

In other embodiments, the fall-arrest apparatus includes a harness adapted to be worn around the upper body of a user, a lanyard having first and second ends, the first end adapted to be secured at a location on the elevated structure, an upper body strap connected to the harness and having at least one end coupled to the second end of the lanyard, a first leg loop and a second leg loop, where each leg loop is adapted to extend around a respective upper leg of the user, a first connecting strap having a first end coupled to the first leg loop and a second end coupled to the second end of the lanyard, and a second connecting strap having a first end coupled to the second leg loop and a second end coupled to the second end of the lanyard. In the event of a fall from the elevated structure, the user is supported by the apparatus in a position where the upper legs are bent relative to the upper body.

In another embodiment, the fall-arrest apparatus includes means for supporting the user in a seated position with the knees elevated at a position at or above the hips when the user is suspended from the elevated structure. In some examples, the fall-arrest apparatus further includes a first strap means for coupling a lanyard to a harness worn by the user and a second strap means for coupling the lanyard to an upper leg of the user, and in particular examples the fall-arrest apparatus also includes a third strap means for coupling the lanyard to a second upper leg of the user. In even more particular examples, the first strap means extends through portions of the harness adjacent the shoulders of the user.

Also disclosed here is a method for preventing suspension trauma in a user of a fall-arrest harness. The method includes coupling the user's fall-arrest harness to a lanyard that is coupled to an elevated structure, coupling a lower body strap assembly to the lanyard, and securing the lower body strap assembly to the upper legs of the user. In the event of a fall, the harness and lower body strap assembly support the user in a seated position with the knees elevated to at least hip level.

### BRIEF DESCRIPTION OF THE DRAWINGS

FIG. 1 is a front schematic view of a user wearing a conventional body harness and an exemplary strap assembly adapted to be used with the body harness to support the user in a seated position in the event of a fall, according to one embodiment.

FIG. 2 is a rear schematic view of the user showing the body harness and the strap assembly of FIG. 1.

FIG. 3 shows a user wearing the body harness and the strap assembly of FIG. 1 being suspended in a sitting position with the legs elevated to minimize the risk of suspension trauma.

FIG. 4 is a perspective view of a leg loop of the strap assembly.

FIG. 5 is a perspective view of an alternate embodiment of the leg loop of the strap assembly.

FIG. 6 is a front schematic view of a user wearing a conventional body harness and an exemplary strap assembly adapted to be used with the body harness to support the user in a seated position in the event of a fall, according to an alternative embodiment.

FIG. 7 is a rear schematic view of the user showing the body harness and the strap assembly of FIG. 6.

FIG. 8A is a plan view of the connecting straps of the lower body strap assembly.

FIG. 8B is a plan view of the upper body strap of the strap assembly.

FIG. 9 is a perspective view of the lower end portion of the upper body strap.

FIG. 10 is a digital image showing the postures for the CHEST, BACK, and ACCESS suspension tests. The mean back angle (from vertical) for the BACK suspension was 41°.

FIG. 11 is a graph showing Kaplan-Meier suspension tolerance probability curves for the CHEST (n=36) and BACK (n=37) suspension tests. Symbols (▪ and ) depict voluntary terminations.

### DETAILED DESCRIPTION

The present disclosure concerns an improved fall-arrest harness that reduces the risk of suspension trauma, a potentially fatal form of orthostatic intolerance. Orthostatic intolerance refers to the development of symptoms such as light-headedness, palpitations, tremulousness, poor concentration, fatigue, nausea, dizziness, headache, sweating, weakness, and occasionally fainting while the body is in a vertical position, particularly for long periods of time. For instance, when a person stands motionless, blood can accumulate in the leg veins (e.g., venous pooling) and cause orthostatic intolerance. Orthostatic intolerance also can occur when an individual moves suddenly after being sedentary for a long time, for instance when standing up quickly after sitting still for a long period of time.

Venous pooling typically occurs in the legs due to the force of gravity and a lack of movement. Blood normally is moved back from the leg veins to the heart through one-way valves using the normal muscular action associated with limb movement. However, if the legs are immobile, then these “muscle pumps” may not operate effectively, and venous pooling can occur. Since veins are expandable, a large volume of blood may accumulate in the veins.

Venous pooling reduces the amount of blood in circulation. The body reacts to this reduction by increasing the heart rate in an attempt to maintain sufficient blood flow to the brain. However, if the blood supply is significantly reduced, this increase in heart rate is not effective at maintaining adequate brain perfusion. During severe venous pooling, the reduction in blood flowing to the brain causes fainting and can have a deleterious effect on other vital organs, such as the kidneys. The kidneys are very sensitive to blood oxygen, and renal failure can occur with excessive venous pooling. If these conditions continue, they can be fatal.

When orthostatic intolerance occurs in a person who is standing (for instance, a soldier standing at attention for a long period of time), the individual can lose consciousness and collapse into a horizontal position. With the legs, heart, and brain on the same level, blood is once again returned to the heart. Assuming no injuries are caused during the collapse, the individual can quickly regain consciousness, and recovery is likely to be rapid.

A much more serious situation occurs in the case of suspension trauma, for instance in the case of individuals using fall-arrest systems. Following a fall, a safety harness user may remain suspended in the harness in a vertical or near-vertical position. The resulting sustained immobility in this position can lead to a state of unconsciousness. Depending on the length of time the suspended person is unconscious and/or immobile and the level of venous pooling, the resulting orthostatic intolerance will sometimes lead to death. Such injuries and fatalities are referred to as “harness-induced pathology” or “suspension trauma.” Symptoms of suspension trauma include faintness, nausea, shortness of breath, dizziness, sweating, unusually low or high heart rate, paleness, unusually low blood pressure, hot flashes, and loss of vision or visual disturbances. Factors that can affect the degree of risk of suspension trauma include the inability to move the legs, hypothermia, pain, shock, injuries sustained during the initial fall, pre-existing cardiovascular disease, fatigue, respiratory disease, dehydration, and blood loss.

Users of conventional fall-arrest harnesses who are unconscious or immobile while suspended in their harness are not able to move their legs and will not fall into a horizontal position, as they would if they fainted while standing. Suspension trauma is particularly likely to result if the suspended individual is left in place for some time. In addition, venous pooling and orthostatic intolerance can be exacerbated by other circumstances related to the fall. For example, shock or the experience of the event that caused the fall, other injuries, the fit or positioning of the harness, the environmental conditions, and the individual's psychological state all can hasten the onset and increase the severity of the condition. Unless the suspended individual is rescued promptly using safe procedures, venous pooling and orthostatic intolerance can result in serious or fatal injury, as the brain, kidneys, and other organs are deprived of oxygen. Suspension in a fall-arrest device can result in unconsciousness and death in less than 30 minutes.

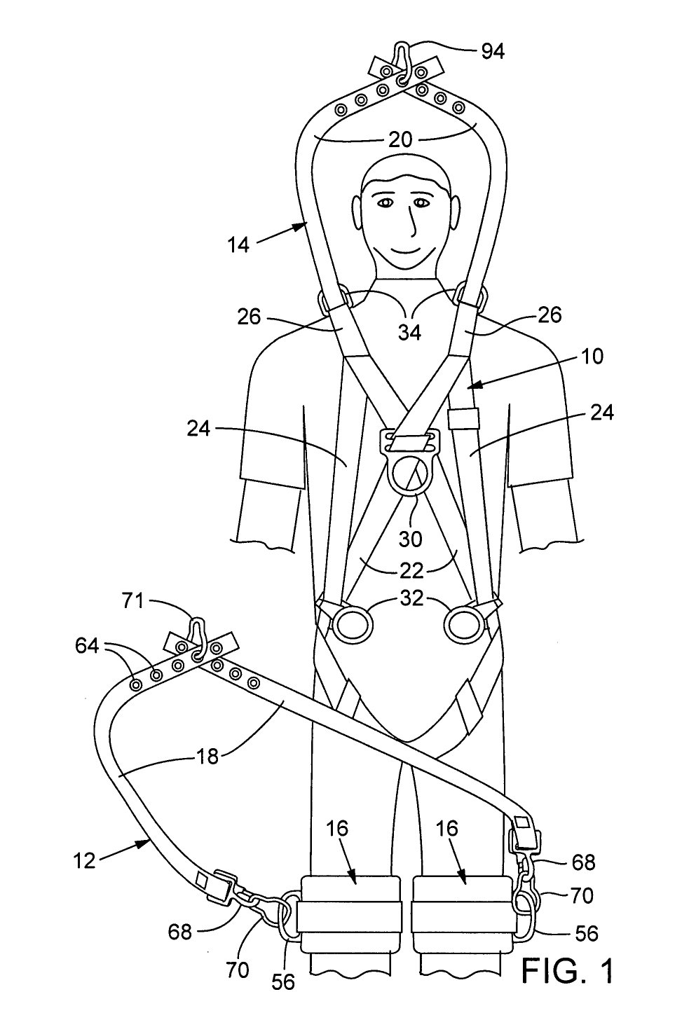

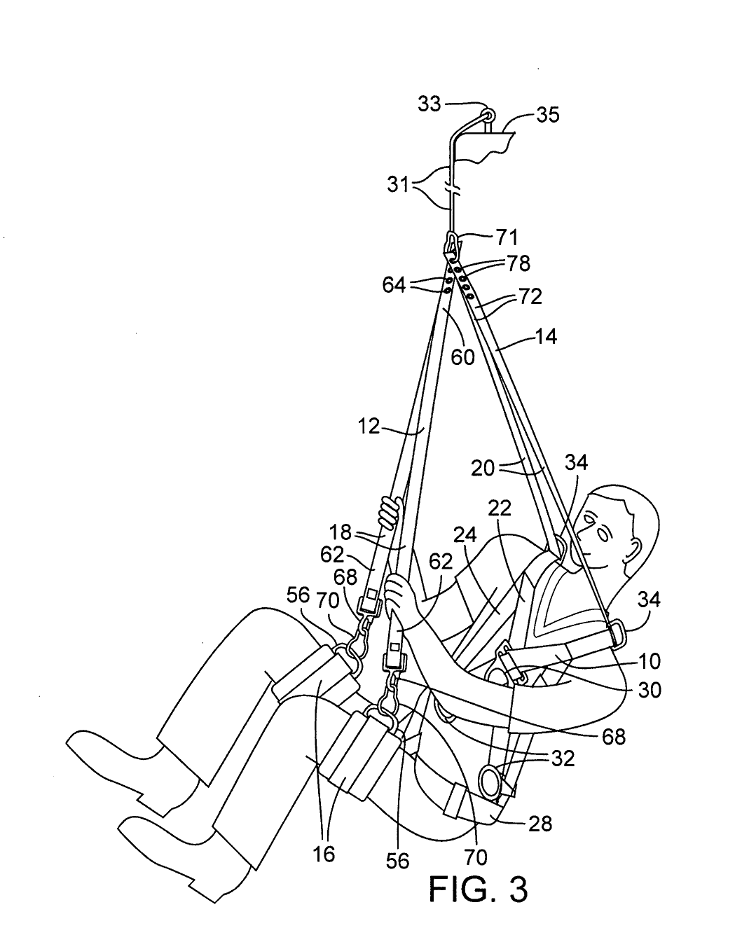

The present disclosure concerns a fall-arrest apparatus for reducing the risk of suspension trauma to a user suspended from an elevated structure by a lanyard. As shown in FIG. 1, the apparatus in particular embodiments can include a harness 10 adapted to be worn around the torso of a user, a lower body strap assembly 12, and an upper body strap assembly 14. The lower body strap assembly 12 (which includes in the exemplary embodiment first and second leg loops 16 and corresponding connecting straps 18) and upper body strap assembly 14 (which includes one or more upper body straps 20) can be used in conjunction with the harness 10. As shown in FIG. 3, in the event of a fall from the elevated structure, the lower body strap assembly 12 and the upper body strap assembly 14 support the user in a seated position with the knees elevated to at least hip level.

The body harness 10 can be of a conventional construction such as shown in FIGS. 1, 2 and 3. Generally, the body harness 10 can have diagonal chest straps 22 (FIG. 1) that cross the body diagonally from shoulder to hip in the front. Additionally, the harness can have vertical chest straps 24 that extend from shoulder to hip on each side of the body. In some embodiments, the diagonal and/or vertical chest straps 22, 24 pass over the shoulders to form the back of the harness (described below), whereas in other embodiments, the diagonal and/or vertical chest straps 22, 24 attach to shoulder straps 26 that pass over the shoulders to form the back of the harness (described below). In addition, the diagonal and/or vertical chest straps 22, 24 connect to pelvis straps 28 adjacent the hips. Generally, the pelvis straps 28 encircle and support the pelvis. In some embodiments, two pelvis straps 28 extend from hip to hip, crossing each other where they pass from the front of the body to the back of the body between the legs, and attaching to one another at their respective end portions adjacent the hips.

As shown in FIG. 1, one or more lanyard attachment elements 30 can be provided on the front of the harness. The attachment elements can be generally ring-shape structures having an aperture for connecting a lanyard and slots through which the straps 22 extend. Optionally, guide rings 32 can be located on the harness front, for example adjacent the hips. The guide rings 32 can be generally ring-shape structures having an aperture for connecting a lanyard and slots through which straps 22, 24 extend. In addition, in some embodiments, additional guide rings 34 can be connected to the shoulder straps 26 adjacent the shoulders. In certain embodiments, the guide rings 34 are D-shaped rings (referred to as “D-rings”).

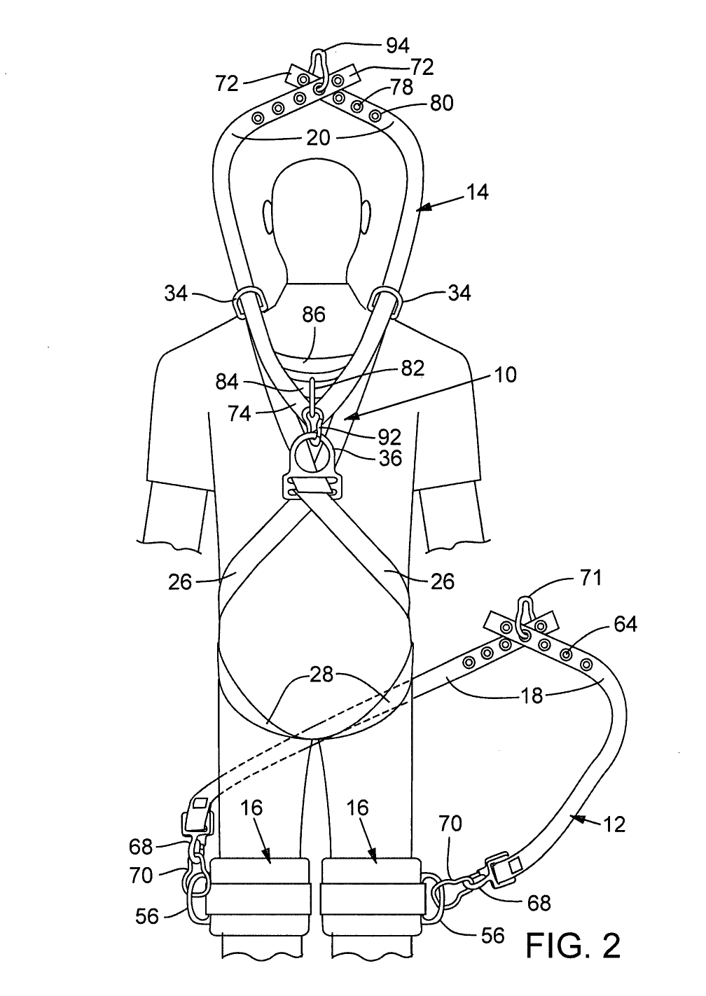

As shown in FIG. 2, the shoulder straps 26 can pass over the shoulders, cross in the back, and connect to the pelvis straps 28 adjacent the hips. One or more attachment elements 36 can be provided on the back of the harness. The attachment element 36 can be generally ring-shape structures having an aperture for connecting a lanyard or another strap and slots through which the shoulder straps 26 extend.

Although a particular exemplary harness is shown in FIGS. 1 and 2, the safety harness 10 can have a variety of different configurations. Such safety harnesses can be constructed of any sturdy material, for example webbing, fabric, rope, cable, or leather. One specific, non-limiting example of a suitable material is 3-inch wide nylon webbing with a tensile strength of 5000 pounds or more. In addition, padding may be provided on any part of the harness, for example under the pelvis straps 28, in order to enhance the comfort and/or fit of the harness.

Specific, non-limiting examples of body harnesses that can be used with the fall-arrest apparatus disclosed herein include the Guardian Premium Edge Harness, Seraph Harness, Construction TUX Harness, Standard HUV Harness, Front-Loop Crossover Harness, Lineman's Harness, Kevlar Harness, Jacket TUX Harness, and the Sport Harness, all manufactured by Guardian Fall Protection, Kent, Wash.; The Miller Revolution Harness, Duraflex Ultra Harness, Duraflex Stretchable Harness, Duraflex Python Ultra Harness, Duraflex Python Harness, HP Harness, ProCraft Harness, Concrete Harness, Construction Harness, Oil Rig Harness, Tower Climbing Harness, Ms. Miller Harness, Warehouse Harness, Titan T4007, Titan T4500, Titan T4507, Titan T4078, Titan T4577, and the Utility Harness, all manufactured by Bacou-Dalloz, Smithfield, R.I.; the DBI Sala and the Protecta, both manufactured by Capital Safety, Red Wing, Minn.; the FallTech 7006P, FallTech 7015, FallTech 7590A, and the FallTech 7595A, all manufactured by FallTech, Inc., South Gate, Calif.; the Gravity Crossover Fall Arrest Harness, Classic Light Weight Harness, FP Classic Quick Fit Harness, FP Pro Harness, Confined Space Fall Arrest Harness, and the Gravity Tower/Rescue Harness, all manufactured by MSA PTY. Limited, Wentworthville, Australia, and the MSA TechnaCurv™ Tower Harness (Pittsburgh, Pa.).

As shown in FIGS. 1 and 2, the harness 10 can be used with the lower body strap assembly 12 to support the user's legs in the event of a fall. In exemplary embodiments, the lower body strap assembly 12 includes leg loops 16, each of which is adapted to extend around a respective upper leg of the user.

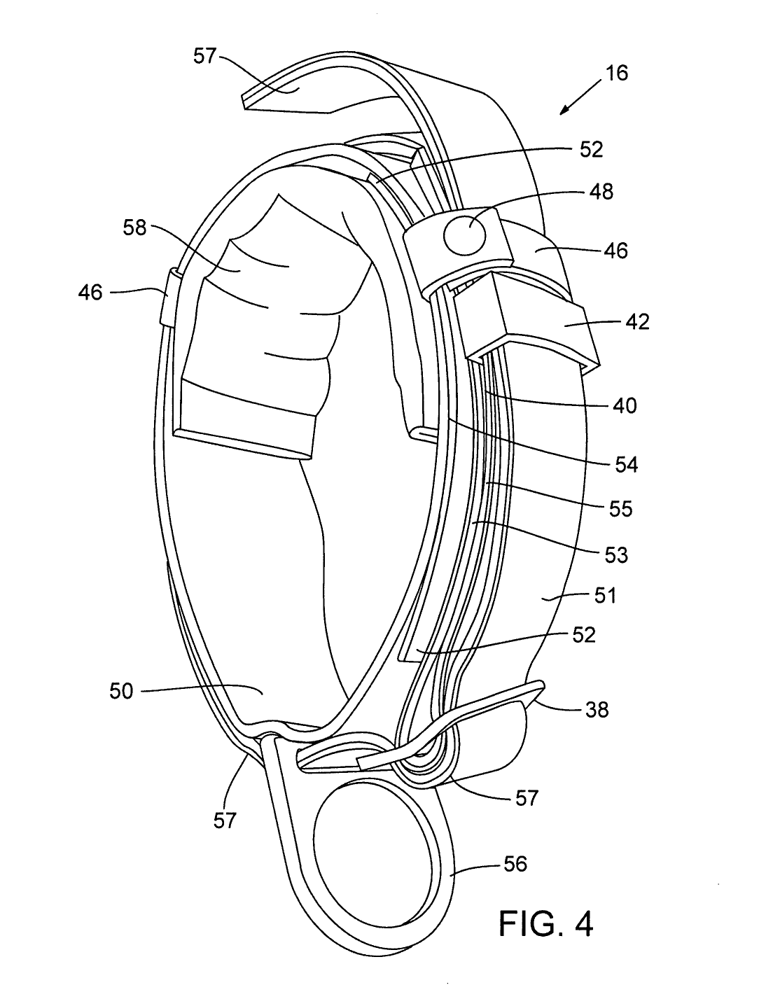

FIG. 4 shows in greater detail the construction of one of the leg loops 16, according to one embodiment. As shown in FIG. 4, the leg loop 16 in the illustrated embodiment includes an inner strap 50 and an outer strap 51 that can be secured to the outer surface of the inner strap 50 at selected locations around the circumference of the leg loop, such as by stitching the inner strap 50 to the outer strap 51 at selected locations. The inner strap 50 can be sized such that its opposite end portions 52 overlap each other in the manner shown in FIG. 4 but desirably are not secured to each other to permit adjustment of the circumference of the leg loop. The outer strap 51 in the illustrated configuration has a first portion 53 that is secured to the inner strap 50 and extends through a buckle 38, a second portion 55 that is folded back against and secured to the first portion 53, and a third portion 57 that is secured to the inner strap 50 and extends through the buckle 38. The circumference of the leg loop 16 can be adjusted by adjusting the position of the buckle 38 along the length of the third portion 57 of the outer strap 51. One or more slides 42 can be mounted on the second strap portion 55 for retaining the free end portion of the third strap portion 57 against the leg loop.

The leg loop 16 also can include a connecting strap attachment element, or ring, 56, which can be a generally ring-shape structure having an aperture for connecting a connecting strap 18 and a slot through which the strap portion 57 extends so as to mount the attachment element 57 to the leg loop. Padding 58 can be provided on the inner surface portion of the inner strap 50 of the leg loop 16. In some embodiments the padding 58 lines the full inner surface of the leg loop 16, wherein in other embodiments the padding 58 lines an inner surface portion of the inner strap 50 of the leg loop at a position that is opposite the connecting strap attachment element 56 (as shown in FIG. 4) such that in use, the padding 58 extends around and relieves pressure on the back of the leg. The padding 58 can be connected to the leg loop by straps 46 that are secured to the padding 58 and extend around the inner strap 50 and the outer strap 51. Strap 46 can be provided with a releasable snap 48 that secures the end portions of the strap to each other.

FIG. 4 shows in greater detail the construction of one of the leg loops 16, according to one embodiment. As shown in FIG. 4, the leg loop 16 in the illustrated embodiment includes an inner strap 50 and an outer strap 51 that can be secured to the outer surface of the inner strap 50 at selected locations around the circumference of the leg loop, such as by stitching the inner strap 50 to the outer strap 51 at selected locations. The inner strap 50 can be sized such that its opposite end portions 52 overlap each other in the manner shown in FIG. 4 but desirably are not secured to each other to permit adjustment of the circumference of the leg loop. The outer strap 51 in the illustrated configuration has a first portion 53 that is secured to the inner strap 50 and extends through a buckle 38, a second portion 55 that is folded back against and secured to the first portion 53, and a third portion 57 that is secured to the inner strap 50 and extends through the buckle 38. The circumference of the leg loop 16 can be adjusted by adjusting the position of the buckle 38 along the length of the third portion 57 of the outer strap 51. One or more slides 42 can be mounted on the second strap portion 55 for retaining the free end portion of the third strap portion 57 against the leg loop.

The leg loop 16 also can include a connecting strap attachment element, or ring, 56, which can be a generally ring-shape structure having an aperture for connecting a connecting strap 18 and a slot through which the strap portion 57 extends so as to mount the attachment element 57 to the leg loop. Padding 58 can be provided on the inner surface portion of the inner strap 50 of the leg loop 16. In some embodiments the padding 58 lines the full inner surface of the leg loop 16, wherein in other embodiments the padding 58 lines an inner surface portion of the inner strap 50 of the leg loop at a position that is opposite the connecting strap attachment element 56 (as shown in FIG. 4) such that in use, the padding 58 extends around and relieves pressure on the back of the leg. The padding 58 can be connected to the leg loop by straps 46 that are secured to the padding 58 and extend around the inner strap 50 and the outer strap 51. Strap 46 can be provided with a releasable snap 48 that secures the end portions of the strap to each other.

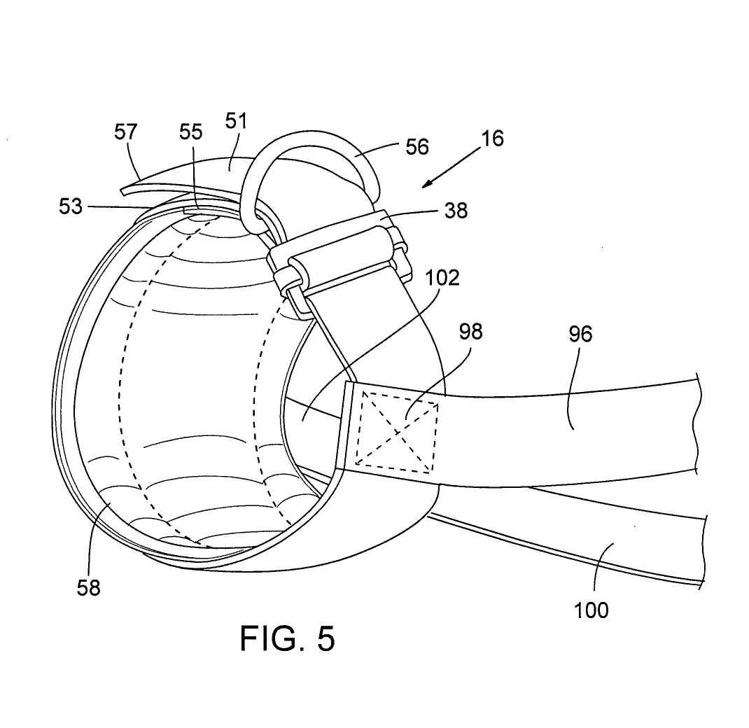

FIG. 5 shows in greater detail the construction of an alternate embodiment of a leg loop 16. As shown in FIG. 5, the leg loop 16 in the illustrated embodiment includes a strap 51 that has a first portion 53 that extends through a buckle 38, a second portion 55 that is folded back against and secured to the first portion 53, and a third portion 57 that extends through the buckle 38. The circumference of the leg loop 16 can be adjusted by adjusting the position of the buckle 38 along the length of the third portion 57 of the strap 51.

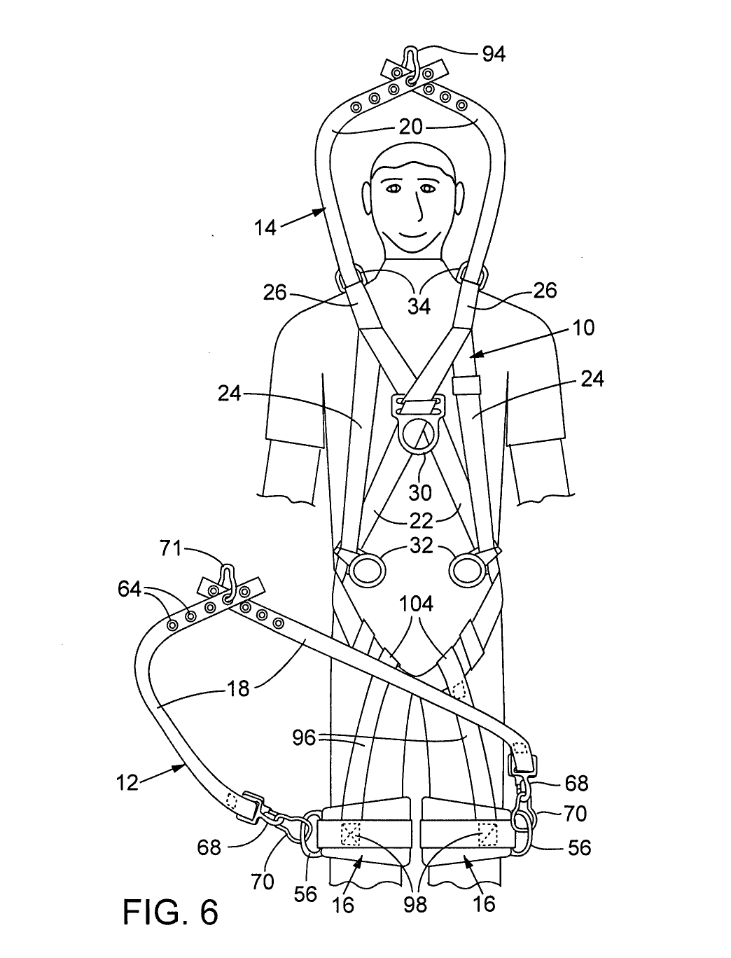

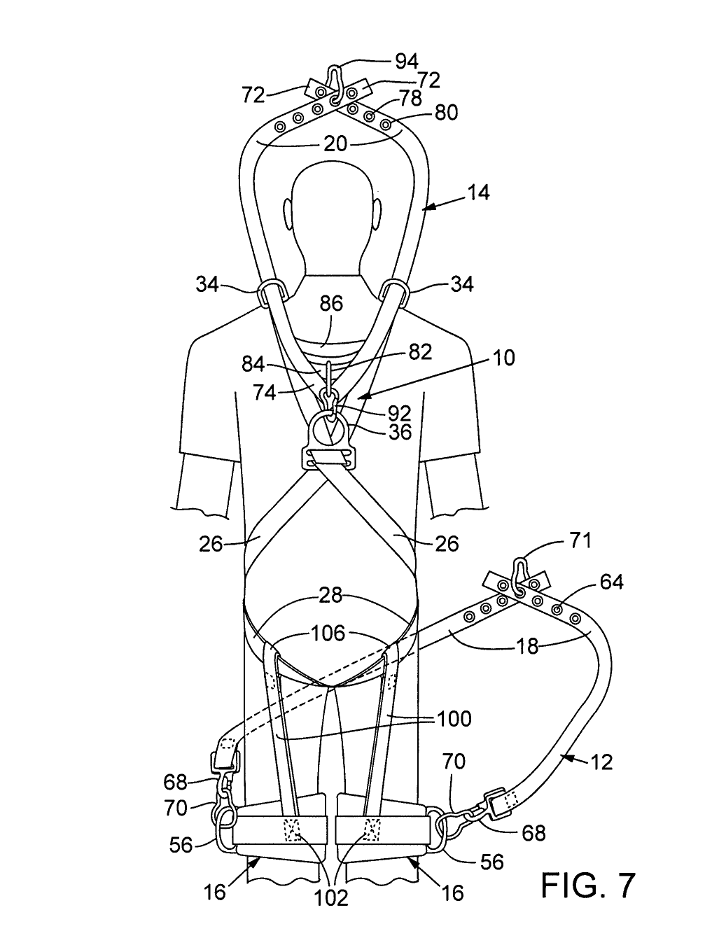

In this alternate embodiment, the leg loop 16 also can include a connecting strap attachment element, or ring, 56, which can be a generally ring-shape structure having an aperture for connecting a connecting strap 18 (FIGS. 6 and 7) and through which the strap portion 57 extends so as to mount the attachment element 57 to the leg loop. Padding 58 can be provided on the inner surface portion of the leg loop 16. In some embodiments, the padding 58 lines the full inner surface of the leg loop 16, wherein in other embodiments the padding 58 lines an inner surface portion of the inner strap 50 of the leg loop at a position that is opposite the connecting strap attachment element 56 (as shown in FIG. 5) such that in use, the padding 58 extends around and relieves pressure on the back of the leg.

As shown in FIG. 5, a front leg loop retention strap 96 can be coupled to the front of the leg loop 16 at a first end portion 98 of the strap 96 of the strap 96 via stitching (as shown in the illustrated embodiment), or via a fastener, which can take the form of a clip, a carabiner, or a D-ring, for instance. In addition to or in lieu of the front leg loop retention strap 96, a rear leg loop retention strap 100 can be similarly coupled to the rear of the leg loop 16 at a first end portion 102 of the strap 100. As shown in FIGS. 6 and 7, the front leg loop retention straps 96 and the rear leg loop retention straps 100 can be connected to the harness 10 at their respective second end portions 104, 106 in order to aid in retaining the leg loops 16 in a position on the upper legs of a user. The front and rear leg loop retention straps 96, 100 can be secured to the harness 10 by stitching (as shown in the illustrated embodiments), or via a fastener, which can take the form of a clip, a carabiner, or a D-ring, for instance, and the distance between the leg loops 16 and the harness 10 optionally may be adjustable, for instance by providing a plurality of apertures spaced along the length of the second end portion 104, 106 of each front and rear leg loop retention strap 96, through which the front or rear leg loop retention strap 96, 100 can be fastened to the harness 10 with a clip or other fastener, or by providing a slidable buckle.

The leg loop 16 can be constructed from any sturdy material, including fabric, leather, rope, cable, or webbing, or a combination for materials. One specific, non-limiting example of a suitable material is 3-inch wide nylon webbing with a tensile strength of at least 5000 pounds.

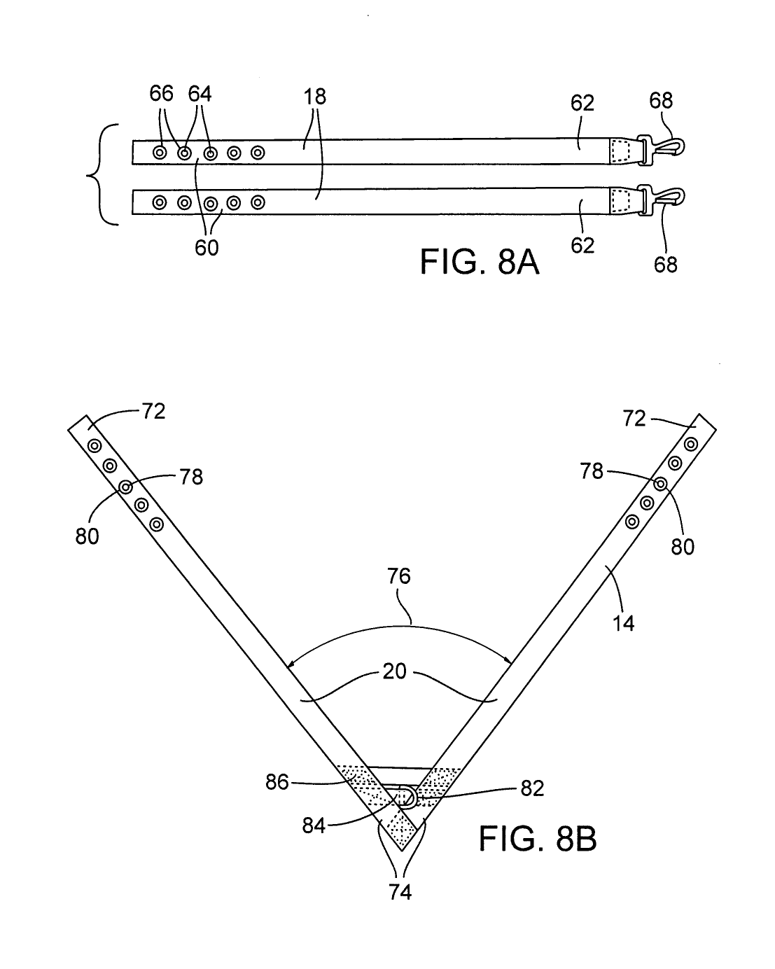

As shown in FIGS. 1, 2, and 3, in use, the leg loops 16 are coupled to the connecting straps 18, which, in turn, are coupled to a lanyard 31. As shown in FIG. 8A, each connecting strap 18 has a first end portion 60 that can be connected to the lanyard 31 and a second end portion 62 that can be connected to a respective leg loop 16. The distance between the leg loops 16 and the lanyard 31 optionally may be adjustable, for instance by providing a plurality of apertures 64 spaced along the length of the first end portion 60 of each strap 18. The apertures 64 can be reinforced by grommets 66. The grommets 66 can be made of metal, and in particular examples they have an inner diameter of about one-half inch. The second end portion 62 of each connecting strap 18 can be connected to a respective leg loop 16 via a fastener 68, which can take the form of a clip (as shown in the illustrated embodiment), a carabiner, or a D-ring, for instance. The fasteners 68 can be connected directly to the connecting strap attachment elements 56, or they can be attached to the connecting strap connecting elements 56 via intermediate connecting rings 70 (as shown in FIG. 1).

In an alternative embodiment, a single connecting strap can be used in place of two connecting straps 18. In this alternative embodiment, the single connecting strap has fasteners at its opposite ends, each of which can be connected to a leg loop 16. An additional fastener that can be used to connect the strap to the lanyard 31 is secured to the strap at an intermediate location between the strap ends.

In another alternative embodiment, a single connecting strap 18 can be used that has a first end portion 60 that can be connected to the lanyard 31 and a second end portion 62 that can be connected to two leg loops 16. In this alternative embodiment, each leg loop 16 is connected to the second end portion 62 of the connecting strap 18 via fasteners 68 such that the distance between the two leg loops 16 is sufficient to permit freedom of movement for the user (e.g., allow the user to walk, kneel, and/or perform other intended tasks).

The connecting straps 18 can be constructed from any sturdy material, including fabric, leather, rope, cable, or webbing, or a combination for materials. One specific, non-limiting example of a suitable material is 2-inch wide nylon webbing with a tensile strength of at least 5000 pounds.

In use, as shown in FIG. 3, and in accordance with one exemplary embodiment, a wearer of the body harness 10 fastens a leg loop 16 to each leg between the knee and hip. The second end portion 62 (not shown in FIG. 3) of each connecting strap 18 can be connected to the connecting strap attachment element 56 of a corresponding leg loop using a fastener 68. The straps 18 can be connected to the leg loops 16 by connecting the fasteners 68 to the rings 70. Optionally, the fasteners 68 can be connected directly to the attachment elements 56 and the rings 70 can be omitted. The first end portion 60 of each connecting strap 18 can be connected via an aperture 64 to a releasable fastener 71, such as a carabiner. The fastener 71 can be connected to one end of the lanyard 31, the opposite end of which can be secured to an anchor 33 on an elevated structure 35. The distance between the lanyard 31 and the leg loops 16 can be adjusted by connecting the fastener 71 at different apertures 64 along the first end portions 60 of the connecting straps 18. Desirably, the distance between the lanyard 31 and the leg loops 16 is sufficient to permit freedom of movement for the user (e.g., allow the user to walk, kneel, and/or perform other intended tasks), while also being sufficiently short to elevate the legs to at least hip level as shown in FIG. 3 in the event that the user becomes suspended from the elevated structure by the lanyard 31. In some embodiments, the legs are elevated higher than hip level, for example at the level of the heart. Elevation of the legs to at least hip level reduces venous pooling in the legs, enhances return blood flow to the heart, and reduces the incidence and severity of suspension trauma.

As shown in FIGS. 1, 2, and 3, the fall-arrest apparatus also can include an upper body strap assembly 14 that is connected to the lanyard 31 and harness 10 for supporting the upper body in the event of a fall. In particular embodiments, the strap assembly 14 extends through portions of the harness 10 adjacent the shoulders of the user and has at least one end coupled to the lanyard 31. As shown in FIG. 8B, in one particular, non-limiting example, the upper body strap assembly 14 includes two upper body straps 20, each having a first end portion 72 and a second end portion 74. In this example, the two upper body straps 20 are secured to one another at their respective second end portions 74 at an angle 76 of, for instance, 90 degrees or less. In specific, non-limiting examples, the angle 56 is from about 74 to about 84 degrees, or in more particular examples, from about 76 to about 78 degrees. The two upper body straps can be secured to one another by any suitable techniques or mechanisms, for example using stitching, rivets, or any of various other suitable fasteners.

Optionally, the portions of the upper body straps 20 between the lanyard and the user can be adjustable in length, for example, from about 24 to about 46 inches, or in more particular examples, from about 30 to about 40 inches from the end of the lanyard 31 to the user. For example, the portions of the upper body straps 20 between the end of the lanyard 31 and the user can be made adjustable by providing a plurality of apertures 78 spaced along the length of the first end portions 72 of the straps 20. The apertures 78 can be reinforced with grommets 80. The grommets 80 can be made of metal, and in particular examples they have an inner diameter of about one-half inch. In use, the straps 20 can be connected to the lanyard 31 by placing the connecter 71 through any of the apertures 78 to set the length of the strap portions extending between the lanyard 31 and the user.

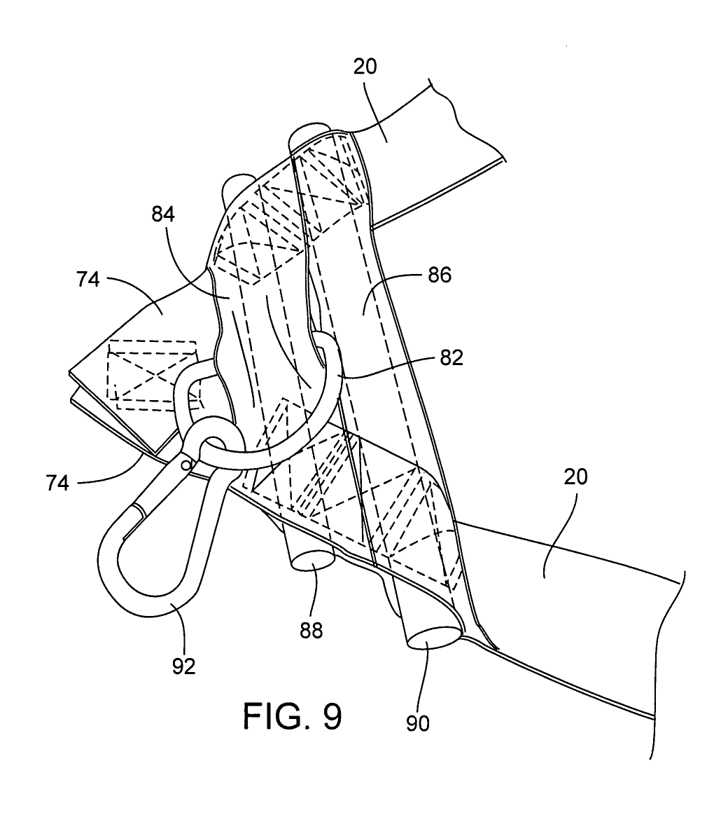

As shown in FIG. 9, the second end portions 74 of the upper body straps 20 can incorporate a harness attachment element 82, which, for example, can take the form of a clip, a carabiner, or a D-ring. The second end portions 74 of the upper body straps also can be reinforced with additional material, for instance with a first cross-piece 84, that extends between and is secured to the second end portions 74, such as by stitching the cross-piece 84 to the end portions 74. In particular exemplary embodiments, the harness attachment element 82 attaches to the first cross-piece 84. A second cross-piece 86, located adjacent the first cross-piece 84, can also be secured to the end portions 74 to further reinforce the connection between the end portions 74. Each of the cross-pieces 84, 86 can be formed from two separate layers of material, between which a respective rod 88, 90 can be inserted. These rods 88, 90 can be made of any sturdy material, for instance, metal, wood, plastic, fiberglass, or the like. In certain examples, one of the rods 88, 90 passes through the harness attachment element 82.

In alternative embodiments, the upper body strap assembly 18 can take the form of a single strap, rather than two straps connected to each other. In this alternative embodiment, the strap can have a releasable connector (e.g., a carabiner) secured at an intermediate location between the ends of the strap. The strap can be inserted through the shoulder rings 34 and connect to the lanyard 31 at its opposite end portions.

Alternatively, the upper body strap assembly can take the form of two individual straps that are not connected to each other. Each strap has a first end adapted to be connected to the body harness 10 at either the front lanyard attachment element 30 or the back lanyard attachment element 36 and a second end adapted to be connected at the lanyard.

In use, the upper body strap assembly 14 can be secured to the harness 10 at the harness attachment element 82 (FIG. 2). In some embodiments, the harness attachment element 82 can be connected to the harness 10 using a fastener 94, such as the illustrated carabiner or an equivalent mechanism, which in turn can be connected to the back lanyard attachment element 36. In the illustrated embodiment, the upper body straps 20 pass over the shoulders and are connected to the lanyard 31 at their first end portions 72. As shown in FIG. 3, the first end portions 72 can be connected to the lanyard 31 with the carabiner 71, which extends through the apertures 78 in the first end portions 72 and through the apertures 64 in the straps 18. Alternatively, the straps 18 can be connected to the lanyard 31 with carabiner 71 while the straps 20 can be connected to the lanyard 31 with a separate carabiner 94 (FIGS. 1 and 2). In certain examples, the upper body straps 20 can be inserted through portions of the harness 10 adjacent the shoulders of the user, for instance, the D-rings 34.

In other examples, the upper body strap assembly 14 can be attached to the harness 10 at the front lanyard attachment element 30 (FIG. 1). In this embodiment, the upper body straps 20 can be inserted through the shoulder rings 34 before being coupled to the lanyard 31 at their respective first end portions 72. The first ends of the upper body straps 20 can be connected to the lanyard 31 the carabiner 94 or the carabiner 71.

The fall arrest apparatus can be used by a user working on an elevated structure, such as a roof, scaffolding, crane, bridge, or other elevated structure. Desirably, the effective length of the upper body strap assembly 14 between the lanyard 31 and the upper body of the user is adjusted to permit freedom of movement for the user, while also being of sufficient length relative to the effective length of the lower body strap assembly 12 between the lanyard 31 and the leg loops 16 such that the legs are elevated to at least hip level as shown in FIG. 3 in the event that the user becomes suspended from the elevated structure by the lanyard 31. The device supports the upper legs in the event of a fall, such that the knees are maintained at an elevated position, for example, at or above the heart (preferably, as shown in FIG. 3), or at or above the hips, in order to facilitate blood flow to the heart, thereby reducing the risk of suspension trauma. The fall-arrest apparatus also can be adapted to support a user with the knees at a position below the hips. Although less desirable, blood flow to the heart is facilitated by virtue of the upper legs being supported by the leg loops 16 and the connecting straps 18 even if the knees are below hip level. Advantageously, the device deploys automatically in the event of a fall, and thus requires no action on the part of the wearer, so it can function equally well on an unconscious wearer.

It will be apparent that the precise details of the apparatus described can be varied or modified without departing from the spirit of the described invention. The following example is provided to illustrate certain particular features and/or embodiments. This example should not be construed to limit the invention to the particular features or embodiments described.

### EXAMPLE 1

### Testing of the Suspension Tolerance-Preventing Fall-Arrest Apparatus

This example illustrates the efficacy of a particular improved fall-arrest apparatus in preventing suspension trauma as compared to conventional safety harnesses.

Sample size calculations (two-sided T-test) were used to determine that a sample of 34 subjects was adequate to detect a difference of six minutes in suspension time or 10 mmHg in mean arterial pressure (MAP) with a power of 0.80 (α=0.05). The subjects included twenty-two men and eighteen women weighing less than 300 pounds and ranging in age from 18 to 45 years old. All men (age 34±8 years, weight 80.1±14.1 kg, and height 178.0 m±7.5 cm, values are mean±SD) and 14 women (age 34±9 years, weight 66.7±14.1 kg, and height 163.4±4.5 cm, values are mean±SD) had previous or current construction experience. Institutional review board approval, including informed consent, was obtained prior to any human subject testing. The MSA TechnaCurv™ Tower Harness (Pittsburgh, Pa.) with a pullover design was used for suspension tests. The harness had padding on the shoulder and leg straps and a padded waist belt. Harness fit was evaluated based on the location of shoulder straps, chest D-ring, hip rings, and back D-ring (according to the harness manufacturer's instructions). Fit was evaluated with the subject standing, prior to suspension and prior to the addition of the suspension trauma-preventing fall-arrest apparatus (e.g., the upper body and lower body strap assemblies, also referred to as the “harness accessory”). If the chest D-ring was between two and four inches above or below the center of the sternum, or if the back D-ring was between two and four inches above or below the mid-point between the shoulder blades, the fit was determined to be “fair.” D-ring locations less than two inches from their respective landmarks were deemed to be “good,” and D-ring locations greater than four inches above or below their landmarks were deemed “poor.”

Subjects were randomly assigned chest D-ring (“CHEST”) or back D-ring (“BACK”) attachment points. Suspension trauma-preventing fall-arrest apparatus (e.g., harness accessory, or “ACCESS”) tests were conducted during a four-week period after completion of all CHEST and BACK tests using 26 of the original subjects. For CHEST and BACK suspension tests, measurement of suspension time commenced after standing subjects were raised two inches from the floor. Subjects were raised from a seated position during the ACCESS tests.

The suspension trauma-preventing fall-arrest apparatus used in these tests was designed to deploy passively, in order to be effective when a suspended worker is seriously injured or unconscious. All subjects were asked to remain motionless for as long as they could during suspension tests. They were instructed that they could terminate the suspension at any time without penalty or loss of further participation in the study. Heart rate (HR), electrocardiogram (ECG), and pulse oximetry were continuously measured, and blood pressure (BP) was measured automatically every two minutes at heart level by a Dinamap Pro 1000V3 monitor (GE, Milwaukee, Wis.). Blood pressure was also measured during the last minute of suspension. Minute ventilation was continuously measured by a VivoMetrics LifeShirt (Ventura, Calif.) throughout the suspension period.

The suspension was terminated if suspension duration reached 60 minutes. Medical test termination criteria included the following signs of orthostatic intolerance: 1) a systolic blood pressure decrease of more than 20 mmHg as compared to the pretest value, 2) a diastolic blood pressure decrease of more than 10 mmHg as compared to the pretest value, 3) a heart rate increase of more than 28 beats per minute over pretest value, 4) a heart rate decrease of more than 10 beats per minute from baseline, or 5) a pulse pressure decrease to less than 18 mmHg (Streeten: Orthostatic Disorders of the Circulation. New York: Plenum, 1987). In addition, tests were medically terminated if any of the following signs or symptoms were reported or observed: shortness of breath, nausea, dizziness, or diastolic blood pressure >100 mmHg. Tests terminated due to extreme subject discomfort were reported as voluntary terminations.

The mean changes in physiological variables were analyzed for the effects of gender, body weight, and attachment point using a mixed model repeated measures analysis of variance (SAS institute, Cary, N.C.) on the combined medically- and voluntarily-terminated (“M+V”) CHEST and BACK test data. Suspension durations for the CHEST and BACK tests were analyzed using a Kaplan-Meier survival analysis, and the effects of gender, height and body weight on suspension duration were determined using a Cox regression model (R: A language and environment for statistical computing, Vienna, Austria).

Four men and two women completed only one, not both of the CHEST and BACK suspensions. The 15 men and 11 women who returned for the tests using the suspension trauma-preventing fall-arrest apparatus had subject characteristics identical to the original group of subjects.

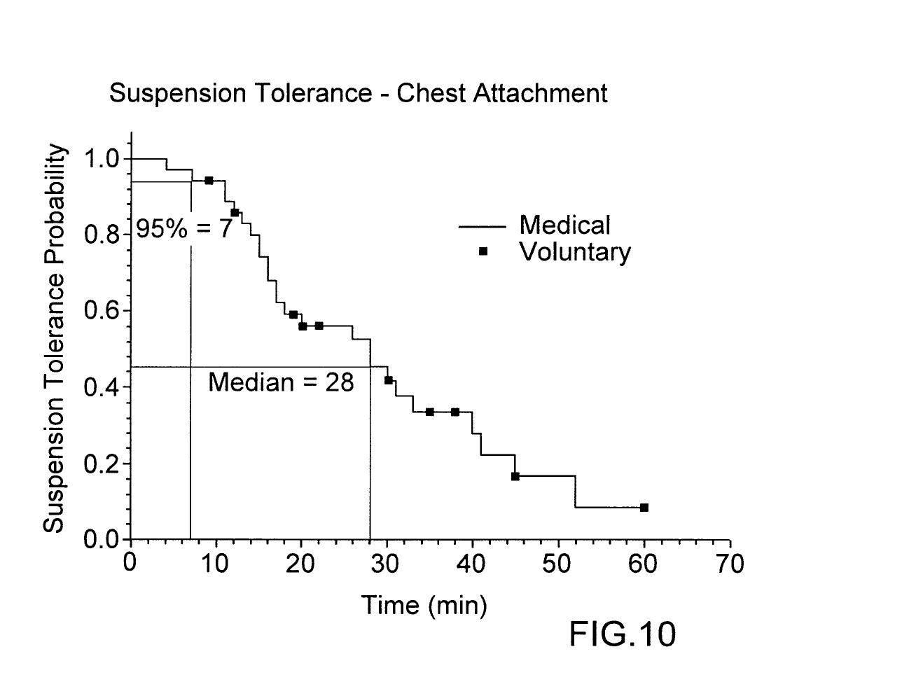

FIG. 10 shows the typical postures for the CHEST, BACK, and ACCESS suspension tests. During BACK suspensions, the mean angle of the subjects' backs was 41° from vertical. Harness fit results and reasons for test termination are shown in Table I. Approximately 48% of men had a fair harness fit before suspension, and 52% had a good fit. Forty percent of women had a poor fit, and 60% had a fair fit. For all CHEST and BACK suspension tests combined, approximately 75% of terminations were due to medical reasons, 23% were due to voluntary requests, and one percent was due to reaching the 60-minute endpoint. There were more voluntary terminations among men for the CHEST condition because of extreme rib discomfort in some subjects caused by the harness waist belt. Among the tests terminated for medical reasons, 25 were due to a decrease in either systolic or diastolic blood pressure (Table II). A decrease in heart rate of ≧10 beats per minute was the cause of three terminations, and a heart rate increase of ≧28 eats per minute led to 20 terminations. Six women and one man experienced other medical signs and symptoms including shortness of breath (2), nausea (1), dizziness (2), and diastolic blood pressure >100 mmHg (3).

The mixed model analysis of variance applied to the M+V data revealed no differences due to gender in any physiological variables, including pretest-to-test-termination changes in thigh circumference, minute ventilation, heart rate, and mean arterial pressure (MAP). Analysis of variance did demonstrate a significant relationship between body weight and change in MAP: during BACK suspensions. The pretest-to-test-termination change in MAP decreased as body weight increased (p≦0.05) for M+V. In addition, decreases in MAP were significantly greater (p≦0.05) with the BACK attachment point than CHEST for M+V. Table III shows separate mean changes in physiological variables for medically- and voluntarily-terminated tests. Changes were generally greater during medically-terminated tests than during voluntary or ACCESS tests.

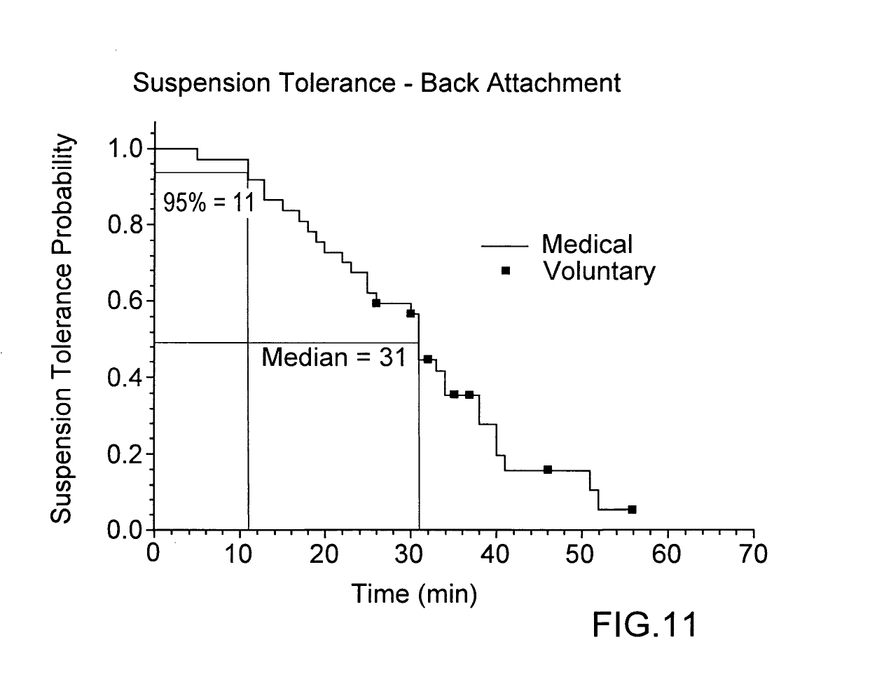

Table IV and FIG. 11 depict the results of the Kaplan-Meier survival analysis used on the suspension duration data from CHEST and BACK suspension tests. The arithmetic mean (±SD) suspension times were 24±13 and 29±12 minutes for CHEST and BACK suspensions, respectively, while medians were 28 and 31 minutes for CHEST and BACK, respectively. The 95^{th} percentile suspension tolerance probability occurred at seven minute for CHEST and 11 minutes for BACK. The slopes of the CHEST and BACK suspension tolerance probability curves show that there is no threshold effect for suspension tolerance probability (FIG. 11). There were one and nine subjects who experienced medical signs or symptoms within five and 15 minutes, respectively, during the CHEST suspension. One and six subjects experienced medical signs or symptoms within five and 15 minutes, respectively, during the BACK suspension. Cox regression, applied separately for CHEST and BACK conditions, revealed that body weight (but not height or gender) had a statistically significant effect on the time until experiencing a medical endpoint (p≦0.05) during the BACK condition. The hazard ratio estimate of 1.03 indicates a three percent increase in risk of developing medical signs or symptoms for every one kg increase in body weight during BACK suspension.

The arithmetic mean for the ACCESS condition (e.g., the suspension trauma-reducing apparatus) was 58 minutes, median was >60 minutes (medical symptoms, if they occur, would occur sometime after 60 minutes), and range was 39-60 minutes (Table IV). There were no terminations due to medical symptoms, changes in physiological variables were small, and 85% of ACCESS subjects completed 60-minutes suspensions.

Most prior suspension tolerance research was conducted on young, healthy members of the military service (Brinkley, Proceedings of the 1^{st} International Fall Protection Symposium, Toronto, Canada, International Society for Fall Protection, pp. 51-65 (1988)). By comparison, the tests described herein were conducted on healthy men and women with a mean age of 34 years, and may be more applicable to the general population of construction workers (mean age 37.2 years; “Worker Age in Construction and Other industries.” Section 14 of The Construction Chartbook, Third Edition, 2002. Available at http://www.cdc.gov/eLCOSH/docs/d0100/d000038/sect14.html (last accessed Jan. 12, 2007)). The 75-to-25% ratio for medical-to-voluntary terminations described herein demonstrates that 60 minutes is an adequate suspension time for identifying and measuring improvements in suspension tolerance.

The tests described herein revealed no effects of gender on suspension tolerance. As previously reported (Hsiao et al., Ergonomics, 46(12):1233-1258 (2003)), harness fit was generally worse for women than for men. Harness fit was assessed with subjects standing before being suspended and may not reflect fit during suspension. Appropriate fit and proper wearing of full-body harnesses are essential for successful fall arrest.

In the majority of medically terminated CHEST and BACK tests, the reason for termination was either a decrease in blood pressure or an increase in heart rate, or both. Both body weight and the BACK condition were significantly related to a decrease in MAP, findings that are supported by the results of the Cox analysis of BACK suspension times. Previous research has demonstrated that body weight, as well as height, shoulder width, and stomach girth, can help predict suspension tolerance (Seddon, Harness Suspension: Review and Evaluation of Existing Information, Health and Safety Executive, Research Report 451/2002 (2002)).

The Kaplan-Meier suspension tolerance probability curves (FIG. 11) are helpful in determining minimum rescue times for suspended workers who are motionless. For instance, if rescue occurs in 31 minutes for a suspension with a back attachment point, 50% of workers likely will have experienced medical symptoms of orthostatic intolerance. In order to ensure that no more than five percent of workers would experience symptoms, rescue would have to occur within seven minutes for a chest attachment point and eleven minutes for a back attachment point.

A major cause of orthostatic intolerance during vertical suspension is the pooling of blood in the veins of the upper legs and in the abdominal and pelvic regions. The support provided to the upper legs, as well as possible compression of the abdomen, by the suspension trauma-prevention fall-arrest apparatus (harness accessory) prevented all medical signs and symptoms during 26 ACCESS suspensions. The 58-minute mean suspension time attained during ACCESS tests is double the mean suspension times observed during CHEST and BACK, and double the full-body harness suspension times reported in previous research (Seddon, Harness Suspension: Review and Evaluation of Existing Information, Health and Safety Executive, Research Report 451/2002 (2002)). While four subjects terminated their suspensions early due to discomfort, 85% of subjects completed the 60-minute suspension. Thus, the suspension trauma-prevention fall-arrest apparatus (harness accessory, or upper and lower body strap assemblies) is effective in preventing the medical signs and symptoms that are precursors to suspension trauma, and it doubled the tolerable suspension time over that tolerable in a conventional harness without the upper and lower body strap assemblies.

TABLE I
Harness Fit and Reason for Test Termination

| | Harness Fit | | | Reason for Termination | | |
|---|---|---|---|---|---|---|
| | Poor | Fair | Good | Medical | Voluntary | 60 min |
| Condition | (% of tests) | | | (% of tests) | | |
| Men | | | | | | |
| CHEST (n = 20) | 0 | 50 | 50 | 60 | 35 | 5 |
| BACK (n = 20) | 0 | 45 | 55 | 80 | 20 | 0 |
| ACCESS (n = 15) | 0 | 53 | 47 | 0 | 7 | 93 |
| Women | | | | | | |
| CHEST (n = 16) | 37 | 63 | 0 | 81 | 19 | 0 |
| BACK (n = 17) | 41 | 59 | 0 | 82 | 18 | 0 |
| ACCESS (n = 11) | 45 | 55 | 0 | 0 | 27 | 73 |

TABLE II
Number of Tests Terminated for ↓ Heart Rate, ↓ Blood
Pressure, ↑ Heart Rate or Other Medical Reasons

| | | | |
|---|---|---|---|
| ↓ BP* | ↓ HR | ↑ HR | Other** |

| | |
|---|---|
| Condition | (number of tests) |

| | | | | |
|---|---|---|---|---|
| Men | | | | |
| CHEST | 5 | 2 | 4 | 1 |
| BACK | 9 | 0 | 7 | 0 |
| Women | | | | |
| CHEST | 6 | 0 | 4 | 3 |
| BACK | 5 | 1 | 5 | 3 |

*↓ in either systolic or diastolic.
**Other signs and symptoms included shortness of breath, nausea, dizziness, and diastolic blood pressure >100 mmHg.

TABLE III
Mean (±SD) Changes in Thigh Circumference (cm), Minute Ventilation
(L/min) Heart Rate (HR, bpm) and Mean Arterial Pressure (MAP, mmHg) for Medical
and Voluntary Terminations

| | Change | Change in | Change in | Change in |
|---|---|---|---|---|
| | in Thigh Circ. | Min. Vent. | HR | MAP |
| Condition | (cm) | (L/min) | (bpm) | (mmHg) |
| Medical | | | | |
| CHEST (n = 25) | 1.7 ± 1.1 | 1.2 ± 1.8 | 15.8 ± 17.9 | 3.7 ± 21.6 |
| BACK (n = 30) | 2.0 ± 1.0 | 1.8 ± 2.1 | 23.7 ± 14.9 | −5.1 ± 16.6 |
| ACCESS | — | — | — | — |
| Voluntary | | | | |
| CHEST (n = 11) | 0.8 ± 1.1 | 1.0 ± 1.7 | 11.6 ± 10.9 | 9.3 ± 5.6 |
| BACK (n = 7) | 1.6 ± 0.4 | 0.4 ± 3.1 | 12.9 ± 5.5 | 7.9 ± 6.2 |
| ACCESS (60 min, n = 22) | 0.2 ± 1.0 | 0.8 ± 2.6 | 3.2 ± 7.1 | 5.2 ± 7.4 |
| ACCESS (vol., n = 4) | 0.7 ± 0.3 | 0.4 ± 1.8 | 4.8 ± 9.7 | 2.3 ± 4.0 |

TABLE IV
Arithmetic Mean (±SD), Kaplan-Meier Median, 95^{th}
Percentile and Range for Suspension Time (min)

| | Arithmetic | Kaplan Meier | 95^{th} | |
|---|---|---|---|---|
| | Mean | Median | Percentile | Range |
| Condition | (min) | (min) | (min) | (min) |
| CHEST (n = 36) | 24 ± 13 | 28 | 7 | 4–60 |
| BACK (n = 37) | 29 ± 12 | 31 | 11 | 5–56 |
| ACCESS (n = 26) | 58 ± 6 | >60 | — | 39–60 |

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A fall-arrest apparatus for reducing the risk of suspension trauma to a user suspended from an elevated structure by a lanyard, comprising:
a harness adapted to be worn around the torso of a user; and
a lower body strap assembly adapted to be worn on the legs of the user, the lower body strap assembly adapted to be connected to the lanyard in use such that, in the event of a fall from the elevated structure, the lower body strap assembly supports the user in a seated position with the knees elevated to at least hip level.

2. The fall-arrest apparatus of claim 1, wherein the knees are elevated to at least heart-level.

3. The fall-arrest apparatus of claim 1, wherein the lower body strap assembly comprises at least one leg loop adapted to be worn on the user's upper legs.

4. The fall-arrest apparatus of claim 3, wherein the lower body strap assembly comprises a first leg loop and a second leg loop, where each leg loop is adapted to extend around a respective upper leg of the user.

5. The fall-arrest apparatus of claim 4, further comprising a first connecting strap having a first end portion coupled to the first leg loop and a second end portion coupled to the lanyard, and a second connecting strap having a first end portion coupled to the second leg loop and a second end portion coupled to the lanyard.

6. The fall-arrest apparatus of claim 4, wherein the first and second leg loops are adjustable in circumference.

7. The fall-arrest apparatus of claim 4, wherein the first and second leg loops are padded.

8. The fall-arrest apparatus of claim 5, wherein the first and second connecting straps are configured to adjust the length of the connecting straps between the leg loops and the lanyard.

9. The fall-arrest apparatus of claim 5, wherein the second end portion of the first connecting strap and the second end portion of the second connecting strap are coupled to an attachment element, which is further connected to one end portion of the lanyard.

10. The fall-arrest apparatus of claim 5, further comprising an upper body strap assembly extending through portions of the harness adjacent the shoulders of the user and having at least one end coupled to the lanyard.

11. The fall-arrest apparatus of claim 10, wherein the upper body strap assembly comprises a single upper body strap having a first end portion coupled to the lanyard and a second end portion coupled to the lanyard, the upper body strap extending through portions of the harness adjacent the shoulders of the user.

12. The fall-arrest apparatus of claim 10, wherein the upper body strap assembly comprises a first upper body strap having a first end portion coupled to the lanyard and a second upper body strap having a first end portion coupled to the lanyard, the first and second upper body straps each extending through portions of the harness adjacent the shoulders of the user, and the first and second upper body straps each having second end portions that are connected to the harness.

13. A method of using the fall-arrest apparatus of claim 1, comprising wearing the harness and strap assembly of claim 1, wherein the lanyard is attached to the elevated structure.

14. A fall-arrest apparatus for reducing the risk of suspension trauma to a user suspended from an elevated structure, comprising:
a harness adapted to be worn around the upper body of a user;
a lanyard having first and second end portions, the first end portion adapted to be secured at a location on the elevated structure;
an upper body strap assembly having at least one end portion coupled to the second end portion of the lanyard;
a first leg loop and a second leg loop, where each leg loop is adapted to extend around a respective upper leg of the user;
a first connecting strap having a first end portion coupled to the first leg loop and a second end portion coupled to the second end portion of the lanyard; and
a second connecting strap having a first end portion coupled to the second leg loop and a second end portion coupled to the second end portion of the lanyard;
wherein in the event of a fall from the elevated structure, the user is supported by the apparatus with the legs bent relative to the upper body.

15. The fall-arrest apparatus of claim 14, wherein in the event of a fall from the elevated structure, the user is supported by the apparatus in a seated position with the knees elevated at a position at or above the heart.

16. The fall-arrest apparatus of claim 14, wherein the first and second leg loops are adjustable in circumference.

17. The fall-arrest apparatus of claim 16, wherein the first and second leg loops are padded.

18. The fall-arrest apparatus of claim 14, wherein the lengths of the first and second connecting straps between the leg loops and the second end portion of the lanyard are adjustable.

19. The fall-arrest apparatus of claim 14, wherein the upper body strap assembly comprises a single upper body strap having a first end portion coupled to the lanyard and a second end portion coupled to the lanyard, the upper body strap extending through portions of the harness adjacent the shoulders of the user.

20. The fall-arrest apparatus of claim 14, wherein the upper body strap assembly comprises a first upper body strap having a first end portion coupled to the lanyard and a second upper body strap having a first end portion coupled to the lanyard, the first and second upper body straps each extending through portions of the harness adjacent the shoulders of the user, and the first and second upper body straps each having a respective second end portion coupled to the harness.

21. The fall-arrest apparatus of claim 14, wherein the length of the upper body strap between the harness and the second end portion of the lanyard is adjustable.

22. A method of using the fall-arrest apparatus of claim 14, comprising wearing the harness and strap assembly of claim 14, wherein the lanyard is attached to the elevated structure.

23. A fall-arrest apparatus for reducing the risk of suspension trauma to a user suspended from an elevated structure, the fall-arrest apparatus comprising means for supporting the user in a seated position with the knees elevated at a position at or above the hips when the user is suspended from the elevated structure.

24. The fall-arrest apparatus of claim 23, wherein the apparatus further comprises a first strap means for coupling a lanyard to a harness worn by the user and a second strap means for coupling the lanyard to an upper leg of the user.

25. The fall-arrest apparatus of claim 24, wherein the apparatus further comprises a third strap means for coupling the lanyard to the other upper leg of the user.

26. The fall-arrest apparatus of claim 24, wherein the first strap means extends through portions of the harness adjacent the shoulders of the user.

27. A method of using a fall-arrest harness comprising:
coupling the fall-arrest harness to a lanyard that is tied off at a location on an elevated structure;
coupling a lower body strap assembly to the lanyard; and
securing the lower body strap assembly to the upper legs of the user;
wherein in the event of a fall the harness and lower body strap assembly support the user in a seated position with the knees elevated to at least hip level.
